(19) United States
(12) Patent Application Publication
(10) Pub. No.: US 2026/0028863 A1
(43) Pub. Date: Jan. 29, 2026

(54) GUIDE SYSTEM

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/343,709

(22) Filed: Sep. 29, 2025

Related U.S. Application Data
(63) Continuation of application No. PCT/AT2024/060127, filed on Apr. 10, 2024.

(30) Foreign Application Priority Data
Apr. 12, 2023 (AT) A 50264/2023

(51) Int. Cl. E05D 15/56

(52) U.S. Cl. CPC E05D 15/56; E05Y 2201/626; E05Y 2201/684; E05Y 2201/688; E05Y 2900/132; E05Y 2900/148

(57) ABSTRACT

A guide system can guide at least one cover element movable relative to a fixed structure. The guide system includes at least one first guide rail to be fastened to the fixed structure, and at least one second guide rail to be fastened to the at least one cover element and which is movable relative to the at least one first guide rail. The at least one second guide rail, in at least one operating position, preferably in all operating positions, is arranged completely outside an installation space of the at least one first guide rail.

The present application is a continuation of International Application PCT/AT2024/060127 filed on Apr. 10, 2024. Thus, all of the subject matter of International Application PCT/AT2024/060127 is incorporated herein by reference.

### BACKGROUND OF THE INVENTION

The present invention relates to a guide system.

Furthermore, the invention relates to an arrangement with a fixed structure, at least one cover element, and a guide system, and a method for moving at least one cover element by the guide system.

Such guide systems are generally used to move a cover element, such as a window or door, relative to a fixed structure, such as a building wall, whereby the movement usually involves a lateral displacement of the cover element relative to the fixed structure.

Applications for this include conventional sliding windows or doors with frames and casings, whereby the movable cover element, e.g., the sliding window pane, is enclosed in the sash and the sash can be moved sideways along and within the frame inserted in the window or door opening. Such a sliding window or sliding door often comprises at least two cover elements, whereby at least one movable cover element can be slid over a second cover element. The sashes of the cover elements are always located essentially within the frame or within their plane, so that the sliding movement of the cover element is limited by the frame or the opening.

The disadvantage here is that the window or door opening is always covered by at least one cover element, i.e., only one area of the window or door opening is exposed.

### SUMMARY OF THE INVENTION

The purpose of the present invention is to provide a guide system that is more advantageous than the prior art, which makes it possible to completely or largely open an opening in a fixed structure.

This task is solved by a guide system for guiding at least one cover element movable relative to a fixed structure. The guide system comprises at least one first guide rail to be attached to the fixed structure, and at least one second guide rail to be attached to the at least one cover element and which is movable relative to the at least one first guide rail. The at least one second guide rail is arranged completely outside an installation space of the at least one first guide rail in at least one operating position, preferably in all operating positions.

In other words, the first guide rail and the second guide rail are spaced apart from each other, i.e., they are not nested within each other, do not overlap, and do not interlock.

A first major advantage of the invention, or rather the spaced arrangement of the second guide rail relative to the first guide rail, is that the cover element can be moved in such a way that an opening in the fixed structure can be completely exposed. This means that the cover element can be moved at a distance above a fixed structure. Its movement is therefore not limited by the frame or the dimensions of the opening.

Another advantage, particularly in cases where the cover element is or includes a window or door, is that a window or door opening can be left open orthogonally without completely exposing the opening. For example, leaving the cover element open orthogonally in this way can be practical for ventilating a building while keeping the opening blocked and/or inaccessible.

It is particularly preferred that a distance between the at least one first guide rail and the at least one second guide rail is variable. The distance is preferably essentially constant along a longitudinal axis of the first guide rail and/or the second guide rail, so that the first guide rail and the second guide rail are aligned essentially parallel to each other.

The variation in the distance, in particular the orthogonal distance, between the first guide rail or the installation space of the first guide rail and the second guide rail or the installation space of the second guide rail can be changed in particular by moving the cover element.

It is particularly preferred that the operating positions of the guide system comprise:
a first operating position, which corresponds to a closed position of the cover element, and
second operating position, which corresponds to an essentially, preferably outwardly, orthogonally suspended open position of the cover element, and/or
a third operating position, which corresponds to an essentially fully open position of the cover element, in particular one that is shifted sideways.

Preferably, the first guide rail and the second guide rail are further apart from each other in the second operating position and/or the third operating position than in the first operating position, preferably wherein the distance in the first operating position is a minimum distance and/or in the second operating position and/or in the third operating position is a maximum distance.

Preferably, the distance in the second operating position and/or the third operating position is between 50 mm and 200 mm, particularly preferably between 100 mm and 150 mm.

Preferably, the first guide rail and the second guide rail in the third operating position are arranged or can be arranged in a longitudinal direction of the first guide rail and/or the second guide rail with a maximum longitudinal offset, i.e., in particular, are displaced relative to each other, in particular parallel to each other.

Conversely, this means that the first guide rail and the second guide rail are arranged essentially congruently next to each other in the first operating position or the closed position and/or the suspended open position of the cover element in a view, in particular orthogonal to the cover element.

In particularly preferred embodiments, the first guide rail and the second guide rail are connected to each other in a manner that allows them to move relative to each other by at least one articulated lever mechanism, preferably by at least two articulated lever mechanisms, in particular with the second guide rail being suspended from the first guide rail by the articulated lever mechanism.

Preferably, the first guide rail and/or the second guide rail are each designed to guide the at least one articulated lever mechanism, preferably by at least one running carriage, in particular comprising at least one wheel, in particular as part of at least one running carriage, and/or linearly, displaceably along a longitudinal axis of the first guide rail and/or the second guide rail.

The at least one articulated lever mechanism may comprise at least one running carriage, which allows relative displacement between the articulated lever mechanism or parts of the articulated lever mechanism and the first guide rail and/or the second guide rail. The at least one running carriage is supported and/or guided vertically, preferably also horizontally and/or by means of running wheels.

Preferably, the at least one articulated lever mechanism is mounted by at least one groove, in a rotationally positive locking manner and translatorily displaceable along a longitudinal direction of the first guide rail and/or the second guide rail, in particular during a movement of the guide system between the second operating position and the third operating position.

Preferably, the guide system has at least two support levers connected to each other in an articulated manner via a first joint axis, which two support levers each form a support toggle lever, and at least two drive levers connected to each other in an articulated manner via a second joint axis, which two drive levers each form a drive toggle lever, preferably with the first joint axis and the second joint axis running essentially orthogonally to each other.

The guide system can have at least one synchronization device for synchronizing the movement of at least two drive toggle levers, preferably which synchronization device is arranged on the first guide rail and/or has at least one synchronization shaft and/or at least one cable pull.

In preferred embodiments, the guide system is designed to hold a cover element freely cantilevered by means of at least four support toggle levers, in particular with two of the four support toggle levers spaced apart from each other at a minimum support lever distance along the longitudinal direction of the first guide rail and/or the second guide rail.

The minimum support lever distance can be understood, for example, as the distance between two support toggle levers that just about allows the freely cantilevering cover element to be held in a stable position, in particular with the support of at least one tipping moment compensation device.

Furthermore, protection is sought for an arrangement with a fixed structure, at least one cover element, and at least one guide system according to the invention, or embodiments thereof. Preferably, the at least one, in particular essentially rectangular, cover element has two essentially horizontal outer edges and/or frame sections, along each of which at least one guide system is arranged.

In principle, the arrangement may comprise one or more fixed structures, cover elements, and/or guide systems.

In a particularly preferred embodiment of the arrangement, the second guide rail is recessed in the cover element and/or the first guide rail is recessed in the fixed structure, preferably in a frame, and/or the operating position can be completely recessed, preferably in the frame, in the fixed structure and in the cover element.

It is preferable that the guide system is essentially completely enclosed by the fixed structure and the cover element.

It is preferred that the cover element has at least a partial frame to which a pane, e.g., a glass pane, can be attached or is attached, and/or that the fixed structure has an opening that can be covered by the at least one cover element.

In principle, it is also possible for the cover element to have edges and/or strips, at least in some areas, which are reinforced with each other, e.g., by means of panes and/or struts.

Protection is also sought for a method of moving at least one cover element relative to a fixed structure by means of at least one guide system according to the invention, or embodiments thereof, wherein the at least one cover element is moved between at least two operating positions, in particular by moving the cover element.

The method particularly preferably comprises steps:
wherein the cover element is moved from a closed position, in which the distance between the first guide rail and the second guide rail is preferably a minimum distance,
   into a substantially orthogonally suspended open position, in which the distance is preferably a maximum distance, and/or
   into a fully open position, in which the distance is preferably a maximum distance,
and wherein the cover element is moved from the fully open position and/or the orthogonally suspended open position into the closed position.

### BRIEF DESCRIPTION OF THE DRAWINGS

Further advantages and details of advantageous embodiments of the invention will be apparent from the following description with reference to the drawings, in which:

FIG. 1-3 show positions of an embodiment of an arrangement according to the invention,

FIG. 4 shows a position of an embodiment of an arrangement according to the invention,

FIG. 5 shows an example of a fixed structure,

FIG. 6 shows a position of the first arrangement embodiment in cross-section,

FIGS. 7-8 show a position of the first arrangement embodiment in cross-section and in detail,

FIGS. 9-14 show operating positions of an embodiment of a guide system, each in an overall and detailed view,

FIGS. 15-17 show positions of an embodiment of an articulated lever mechanism,

FIG. 18 is an exploded view of an articulated lever mechanism,

FIG. 19 is a detailed view of an articulated lever mechanism, and

FIGS. 20-25 show examples of cover element frame connections.

### DETAILED DESCRIPTION OF THE INVENTION

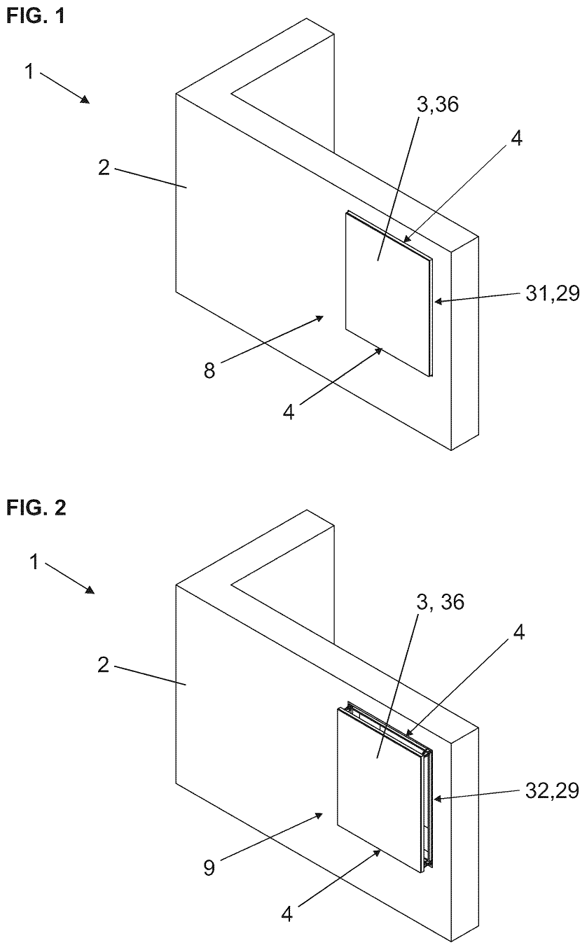

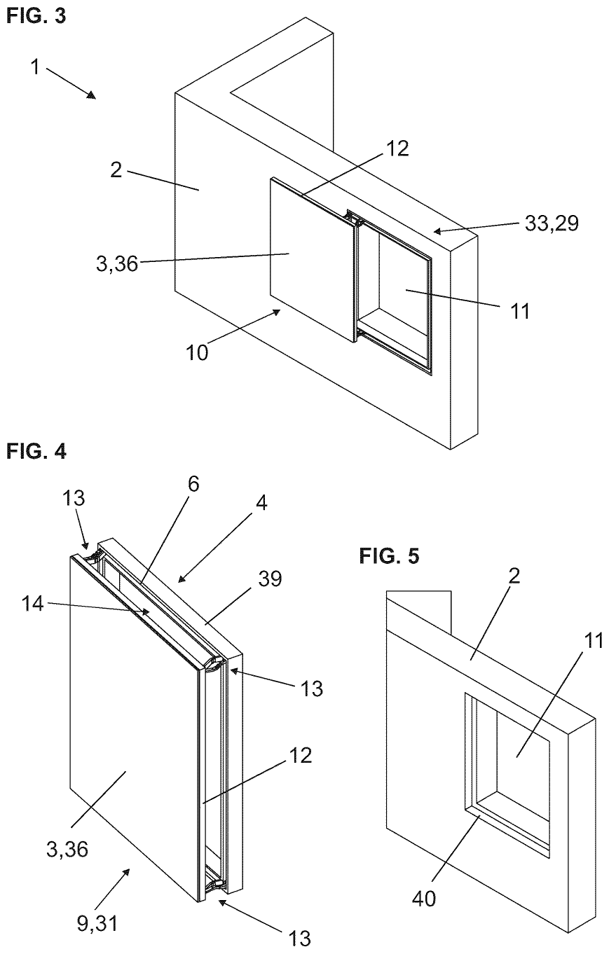

FIGS. 1-3 show positions of a preferred embodiment of an arrangement 1 according to the invention with a fixed structure 2 and a cover element 3, wherein the cover element 3, preferably comprising a pane 36, is in the closed position 8 in FIG. 1, in FIG. 2 in the suspended open position 9, and in FIG. 3 in the fully open position 10.

In this embodiment, arrangement 1 comprises two guide systems 4 for guiding the movement of the cover element 3 relative to the fixed structure 2, whereby the guide system 4 is shown in more detail in the following figures.

The operating positions 29 of the guide systems 4 correspond to the positions of the cover element 3, whereby the first operating position 31 of the guide system 4 corresponds to the closed position 8 (FIG. 1) of the cover element 3, the second operating position 32 corresponds to the suspended open position 9 (FIG. 2) and the third operating position 33 corresponds to the fully open position 10 of the cover element 3.

In the closed position 8 (FIG. 1) of the cover element 3, an opening 11 of the fixed structure 2 is closed and/or the outer edge 12 of the cover element 3, e.g., the window frame touches, essentially the frame 39, e.g., the window frame, preferably with the cover element 3 being essentially flush with the surface of the fixed structure 2.

In the suspended open position 9 (FIG. 2) of the cover element 3, the cover element 3 is in a position that is orthogonally offset from the closed position 8, in particular toward the outside.

In the fully open position 10 (FIG. 3), the cover element 3 is in a position that is shifted sideways relative to the suspended open position 9, so that any opening 11 is essentially completely or largely exposed.

FIG. 4 shows the same embodiment of an arrangement 1 according to the invention, in which the cover element 3, preferably comprising a pane 36, is in the suspended open position 9 and the guide systems 4 are correspondingly in the second operating position 31, wherein a articulated lever mechanism 13 is located at each of the corners of the cover element 3 and/or the frame 39.

FIG. 5 shows an example of a fixed structure 2 with an opening 11 with a reveal 40, into which, for example, the elements of the arrangement 1 shown in FIG. 4, in particular the frame 39 with all elements attached to it, can be inserted.

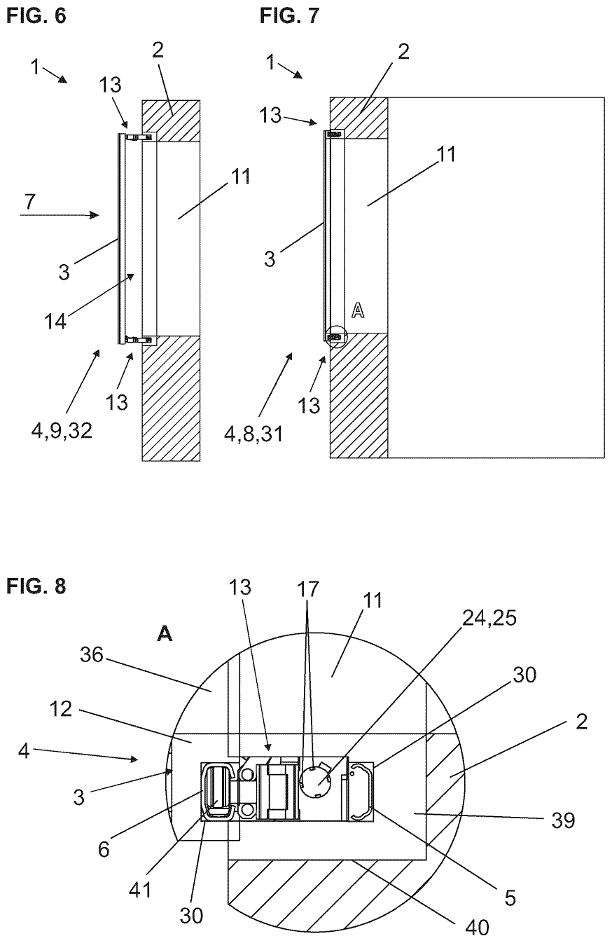

FIG. 6 shows a cross-section of the embodiment of the arrangement 1 shown in FIG. 2, wherein the cover element 3 is in the suspended open position 9 and the guide system 4 is correspondingly in the second operating position 32.

Here, view 7 is shown orthogonally to the cover element 3, in which view 7 the first guide rail 5 and the second guide rail 6 lie essentially congruent on top of each other in the closed position 8 and/or suspended open position 9 of the cover element 3. The first guide rail 5 and the second guide rail 6 are shown in more detail in the detailed section of FIG. 8.

FIGS. 7-8 show a section and a detailed section taken from it of the embodiment of arrangement 1 shown in FIG. 1 in the closed position 8 of the cover element 3, comprising at least one pane 36.

The detailed section in FIG. 8 shows the first guide rail, which is preferably attached or attachable to the frame 39 in the reveal of the fixed structure 2, and the at least one second guide rail 6, which is attached or attachable to the at least one cover element 3 and is movable relative to the first guide rail 5.

In the closed position 8, the second guide rail 6 is recessed in the cover element 3 and the first guide rail 5 is recessed, preferably in the frame 39, in the fixed structure 2, in particular with the guide system 4 being essentially completely enclosed by the fixed structure 2 and/or the frame 39 and the cover element 3.

In this embodiment, the first guide rail 5 and the second guide rail 6 are essentially C-shaped and arranged parallel to each other.

In this embodiment, the second guide rail 6 is arranged completely outside a construction space 30 of the first guide rail 5 in the closed position 8 and/or the suspended open position 9 and/or the fully open position 10, preferably in all three of these operating positions 29.

This detailed view also shows a running carriage 41 mounted so that it can slide in the second guide rail 6.

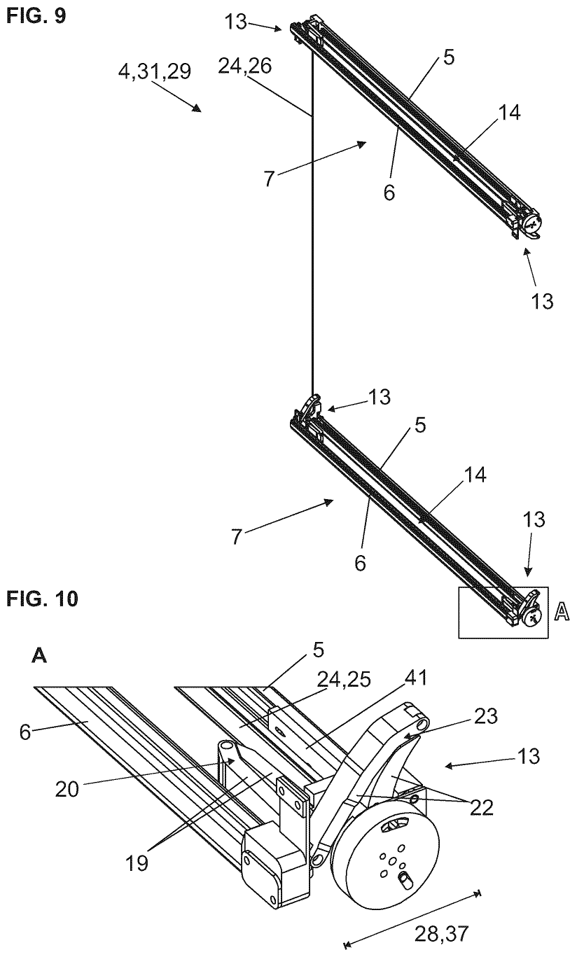

FIGS. 9-14 show operating positions 29 of the same design embodiment of the guide system 4, each in a general view (FIGS. 9, 11, 13) and a corresponding detailed view (FIGS. 10, 12, 14).

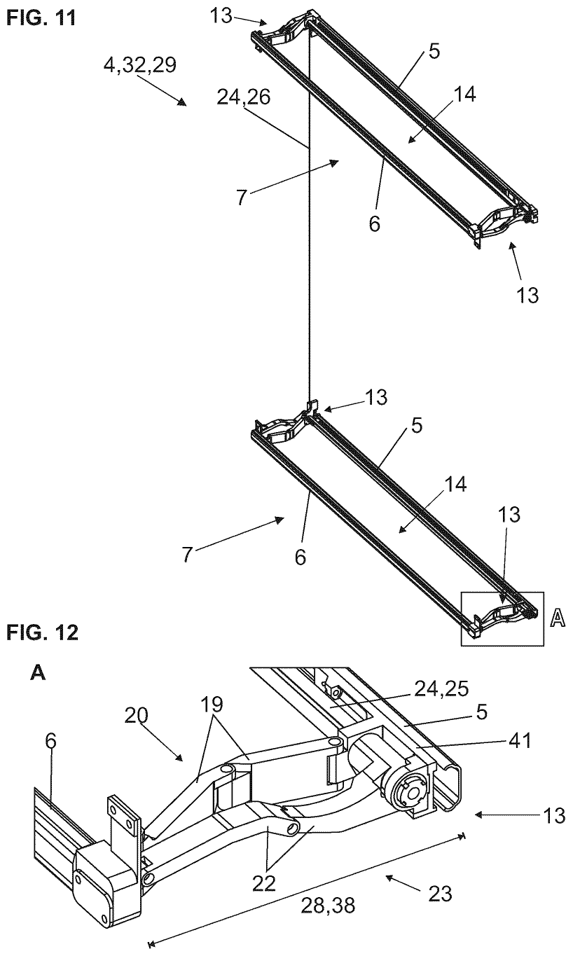

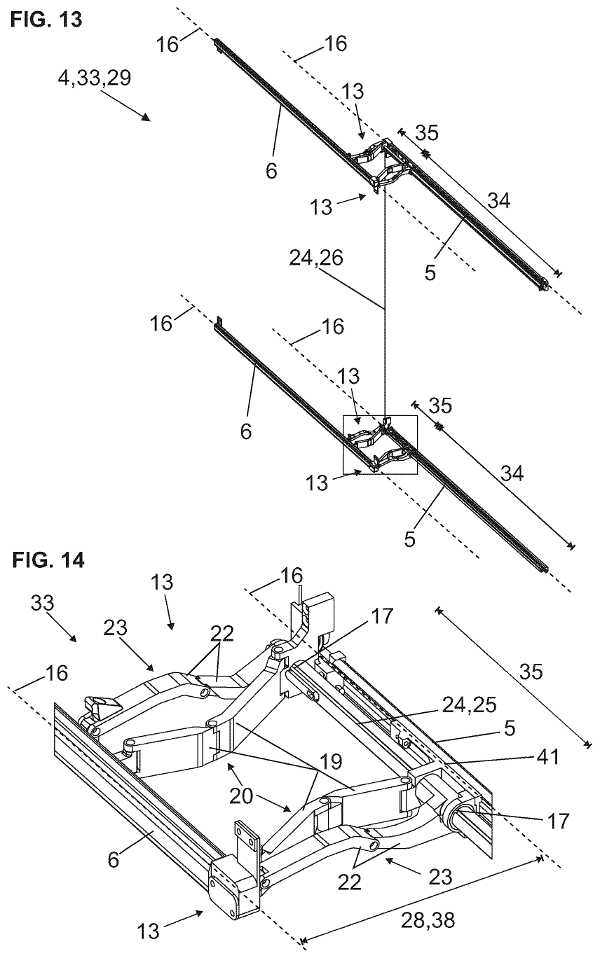

FIGS. 9 and 10 show the guide system 4 in the first operating position 31; FIGS. 11 and 12 show it in the second operating position 32; and FIGS. 13 and 14 show it in the third operating position 33.

This guide system 4 comprises two first guide rails 5 and two second guide rails 6, wherein a first guide rail 5 and a second guide rail 6 are connected to each other in such a way that they can be moved relative to each other by means of two articulated lever mechanisms 13.

In this embodiment, the second guide rails 6 attached to the cover element 3 move relative to the first guide rails 5 attached to the fixed structure 2.

It can be imagined that the second guide rail 6 and the associated first guide rail 5 each span an imaginary volume 14 during a movement of the first guide rail 5 or the cover element 3 with the first guide rail 5, in particular between a closed position 8 and a suspended open position 9 and/or fully open position 10 of the cover element 3, with the at least one articulated lever mechanism 13 remaining essentially within this volume 14.

This embodiment of the guide system 4 comprises at least two support levers 19 connected to each other in an articulated manner via a first joint axis 18, wherein two support levers 19 each form a support toggle lever 20, and at least two drive levers 22 connected to each other in an articulated manner via a second joint axis 21, wherein two drive levers 22 each form a drive toggle lever 23, preferably wherein the first joint axis 18 and the second joint axis 21 run essentially orthogonally to each other.

This embodiment of guide system 4 comprises at least one synchronization device 24 for synchronizing the movement of at least two drive toggle levers 23, preferably which synchronization device 24 is arranged on the first guide rail 5 and/or has at least one synchronization shaft 25 and/or has at least one cable pull 26.

FIGS. 10, 12, and 14 in particular show that the first guide rail 5 and the second guide rail 6 are preferably further apart from each other in the suspended open position 9 (FIG. 12) and/or the fully open position 10 (FIG. 14) of the cover element 3 than in the closed position 8 (FIG. 10), preferably with the first guide rail 5 and the second guide rail 6 having a distance 28 and/or maximum distance 38 of between 50 mm and 200 mm in the suspended open position 9 and/or the fully open position 10 of the cover element 3, particularly preferably a distance 28 and/or maximum distance 38 of between 100 mm and 150 mm.

In the closed position 31 of the cover element 3, the distance 28 is preferably a minimum distance 37 (FIG. 10).

The distance 28 between the first guide rail 5 and the second guide rail 6 can be changed, in particular by moving the second guide rail 5 and/or the cover element 3 to which the second guide rail is attached.

In particular, FIGS. 13 and 14 show that the first guide rail 5 and/or the second guide rail 6 are preferably each designed to support the at least one articulated lever mechanism 13, preferably by means of at least one running carriage 41, in particular comprising at least one running wheel 15, to be guided in a displaceable manner along a longitudinal axis 16 of the first guide rail 5 and/or the second guide rail 6.

It is shown here that the at least one articulated lever mechanism 13 is preferably mounted by means of at least one groove 17, rotationally positive locking and translatorily displaceable along the first guide rail 5 and/or the second guide rail 6.

The guide system 4 is preferably designed to guide the cover element 3 by means of at least four support toggle levers 23, in particular whereby two of the four support toggle levers 23 are spaced apart from each other at a minimum support lever distance along the longitudinal direction 16 of the first guide rail 5 and/or the second guide rail 6, in particular in the fully open position 10 of the cover element 3 and/or the third operating position 33 of the guide system 4, free-standing, see FIGS. 13 and 14.

In the third operating position 33 of the guide system 4, the first guide rail 5 and the second guide rail 6 are preferably spaced apart from each other in a longitudinal direction 16 of the first guide rail 5 and/or the second guide rail 6 by a maximum longitudinal distance 34, i.e., in particular, the first guide rail 5 and the second guide rail 6 are aligned parallel to each other in the longitudinal direction 16.

The operating positions 29 shown in FIGS. 9-14 are preferably achieved by a method for moving the cover element 3 relative to the fixed structure 2 by means of the guide system 4, wherein the at least one cover element 3 is moved between at least two operating positions 29, in particular wherein the distance 28 is variable and/or is changed.

To open the cover element 3 from the closed position 8, in which the distance 28 is preferably a minimum distance 37,
the cover element 3 is moved to an orthogonally suspended open position 9, in which the distance 28 is preferably the maximum distance 38, and/or
the cover element 3 is moved into a fully open position 10, in which the distance 28 is preferably the maximum distance 38.

To close the cover element 3, the cover element 3 is moved into the closed position 8 starting from the fully open position 10 and/or the orthogonally suspended open position 9.

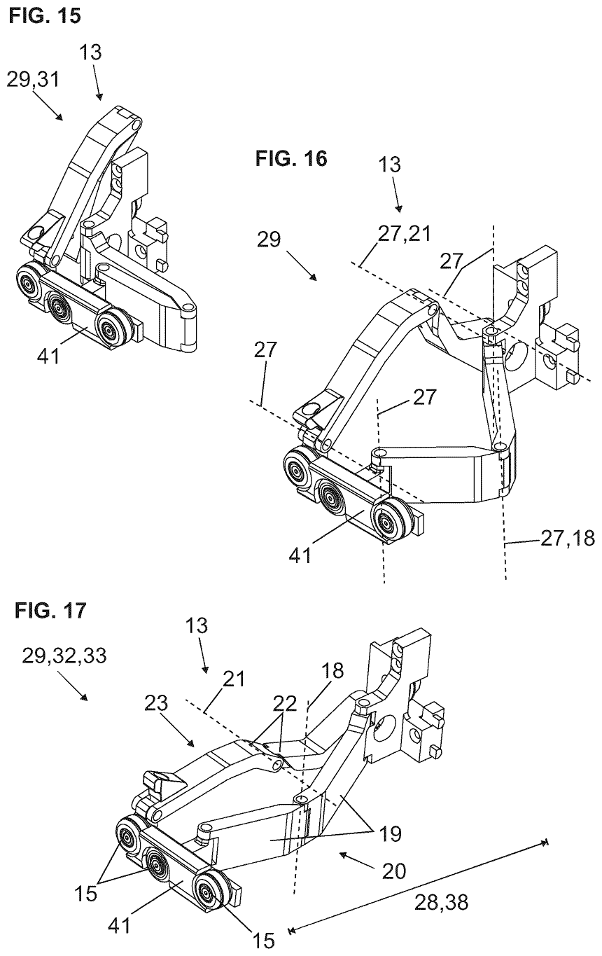

FIGS. 15-17 show positions of a particularly preferred embodiment of an articulated lever mechanism 13, wherein FIG. 15 corresponds to the first operating position 31, FIG. 16 to an intermediate position, and FIG. 17 to the second operating position 32 and/or the third operating position 33 of the guide system 4.

It is shown here that the guide system 4, in particular the articulated lever mechanism 13, has at least two support levers 19 connected to each other in an articulated manner via a first joint axis 18, which two support levers 19 each form a support toggle lever 20, and at least two drive levers 22 connected to each other in an articulated manner via a second joint axis 21, which two drive levers 22 each form a drive toggle lever 23, preferably with the first joint axis 18 and the second joint axis 21 running essentially orthogonally to each other.

It is preferable that the articulated lever mechanism 13 has more than four, preferably exactly six, joint axes 27, and/or has at least one, preferably more than one, support lever 19 and/or drive lever 22, which is curved and/or angled in some areas.

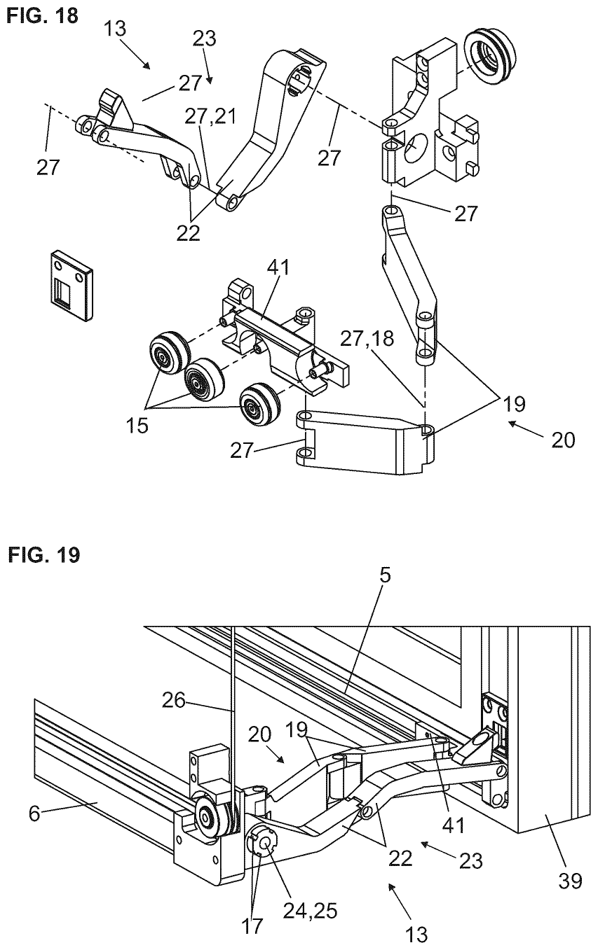

FIG. 18 shows an exploded view of the articulated lever mechanism 13 shown in the preceding figures.

FIG. 19 shows a detailed view of the same articulated lever mechanism 13, which connects the first guide rail 5 inserted into the frame 39 and the second guide rail 6, supports the guide rail 6 and/or enables movement of the second guide rail 6 relative to the first guide rail 5.

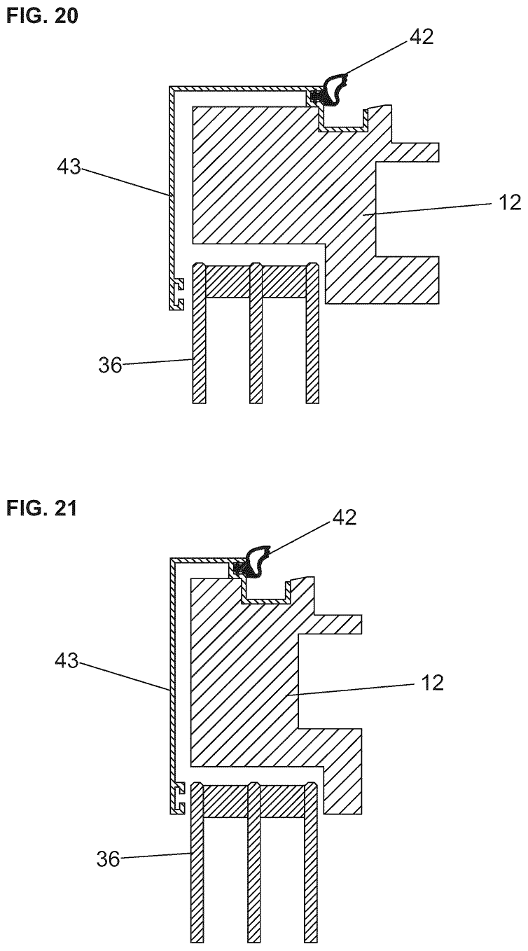

FIGS. 20-25 show details of examples of connections, preferably window or door frame connections, for panes 36, in particular window or door panes, of cover elements 3 for fastening the panes 36 to the outer edges 12 of the cover element 3, wherein the outer edges 12 are designed in particular as frames.

The respective connections comprise at least an outer edge 12 or frame, a pane 36, a seal 42, and a seal receptacle 43.

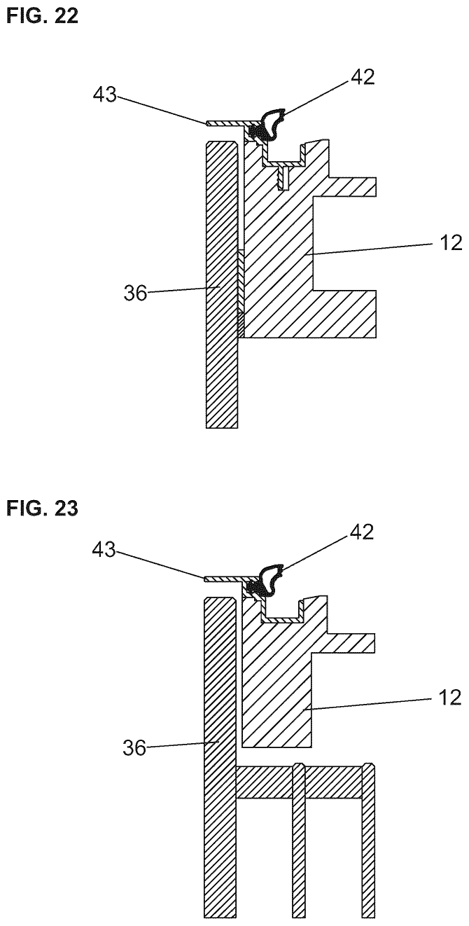

FIGS. 20 and 21 show embodiments of a connection, whereby in each case the outer edge 12 is a wooden frame, the seal holder is an aluminum part, and the pane 36 is a multi-pane insulating glass. FIG. 22 shows an embodiment of a connection, wherein the outer edge 12 is a wooden frame, the seal holder is an aluminum part, and the pane 36 is vacuum insulating glass.

FIG. 23 shows an embodiment of a connection, whereby the outer edge 12 is a wooden frame, the seal holder is an aluminum part, and the pane 36 is stepped-bevel glass.

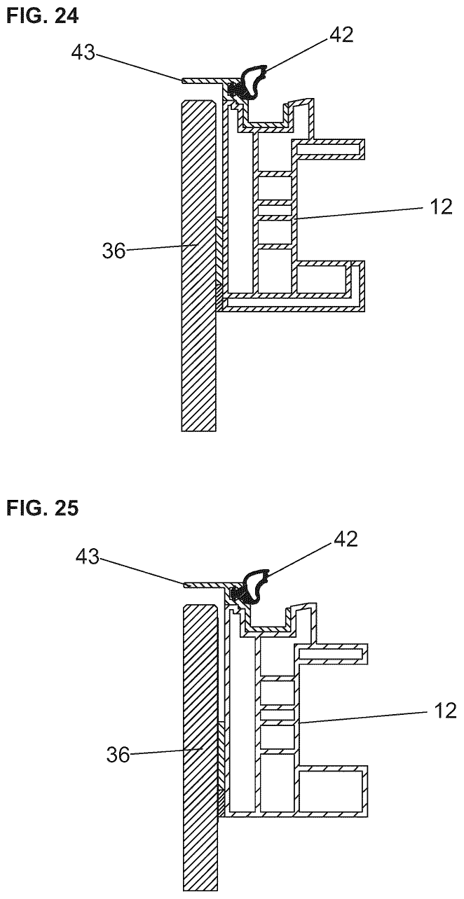

FIG. 24 shows an embodiment of a connection, wherein the outer edge 12 is an aluminum frame, the seal holder is an aluminum part, and the pane 36 is vacuum insulating glass.

FIG. 25 shows an embodiment of a connection in which the outer edge 12 is an aluminum frame, the seal holder is a plastic part, and the pane 36 is vacuum insulating glass.

In principle, however, other designs of such connections are also conceivable.

1. A guide system for guiding at least one cover element movable relative to a fixed structure, the guide system comprising:
at least one first guide rail to be attached to the fixed structure; and
at least one second guide rail to be attached to the at least one cover element which is movable relative to the at least one first guide rail,
wherein the at least one second guide rail is arranged completely outside an installation space of the at least one first guide rail in at least one operating position, preferably in all operating positions.

2. The guide system according to claim 1, wherein a distance between the first guide rail and the second guide rail is variable.

3. The guide system according to claim 1, wherein the operating positions of the guide system comprise:
a first operating position corresponding to a closed position of the cover element, and
a second operating position corresponding to a substantially orthogonally suspended open position of the cover element, and/or
a third operating position corresponding to a substantially fully open position of the cover element, in particular one that is shifted to the side.

4. The guide system according to claim 3, wherein the first guide rail and the second guide rail are further apart from each other in the second operating position and/or the third operating position than in the first operating position, preferably wherein the distance in the second operating position and/or the third operating position is between 50 mm and 200 mm, particularly preferably between 100 mm and 150 mm.

5. The guide system according to claim 3, wherein the first guide rail and the second guide rail in the third operating position are arranged or can be arranged substantially along a longitudinal axis of the first guide rail and/or the second guide rail with a maximum longitudinal offset, in particular parallel to each other.

6. The guide system according to claim 1, wherein the first guide rail and the second guide rail are connected to each other in a manner that allows them to move relative to each other by means of at least one articulated lever mechanism, preferably by means of at least two articulated lever mechanisms.

7. The guide system according to claim 6, wherein the first guide rail and/or the second guide rail is/are designed to guide the at least one articulated lever mechanism, preferably by means of at least one running wheel, along a longitudinal axis of the first guide rail and/or the second guide rail.

8. The guide system according to claim 7, wherein the at least one articulated lever mechanism is mounted, preferably by means of at least one groove, in a rotationally positive locking manner and in a translatorily displaceable manner along the longitudinal axis of the first guide rail and/or the second guide rail.

9. The guide system according to claim 1, wherein the guide system comprises:
at least two support levers connected to each other in an articulated manner via a first joint axis, the two support levers each forming a support toggle lever, and at least two drive levers connected to each other in an articulated manner via a second joint axis, the two drive levers each forming a drive toggle lever, preferably wherein the first joint axis and the second joint axis run substantially orthogonally to each other, and/or
at least one synchronization device for synchronizing the movement of at least two drive toggle levers, preferably wherein the synchronization device is arranged on the first guide rail and/or has at least one synchronization shaft and/or at least one cable pull.

10. The guide system according to claim 9, wherein the guide system is designed to support a cover element by means of at least four support toggle levers, in particular, two of the four support toggle levers being spaced apart from each other at a minimum support lever distance along a longitudinal axis of the first guide rail and/or the second guide rail.

11. An arrangement comprising:
a fixed structure,
at least one cover element, and
the guide system according to claim 1, preferably wherein the at least one, in particular substantially quadrangular, cover element has at least two substantially horizontal outer edges, along each of which at least one guide system is arranged.

12. The arrangement according to claim 11, wherein the second guide rail can be recessed in the cover element and/or the first guide rail can be recessed in the fixed structure, in particular by means of a frame, recessed in the fixed structure, and/or wherein the guide system can be arranged in the first operating position completely recessed in the fixed structure and in the cover element, preferably wherein the guide system is substantially completely enclosed by the fixed structure and the cover element.

13. The arrangement according to claim 11, wherein the cover element has outer edges, e.g., a frame, at least in some areas, to which a pane, e.g., a glass pane, can be attached, and/or wherein the fixed structure has at least one opening that can be covered by the at least one cover element.

14. A method for moving at least one cover element relative to a fixed structure by the guide system according to claim 1, wherein the at least one cover element is moved between at least two operating positions.

15. The method according to claim 14,
wherein the cover element is moved from a closed position, preferably in which a distance between the first guide rail and the second guide rail is a minimum distance,
into a substantially orthogonal suspended open position, in which the distance is preferably a maximum distance, and/or
into a fully open position, in which the distance is preferably a maximum distance, and
wherein the cover element is moved from the fully open position and/or the orthogonally suspended open position into the closed position.
